(19) United States
(12) Patent Application Publication
(10) Pub. No.: US 2007/0211701 A1
(43) Pub. Date: Sep. 13, 2007

(54) Communicating configuration information for an end system

(75) Inventors: Albert V. Smith JR., Richardson, TX (US); Richard J. Dunsmore, McKinney, TX (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 11/369,564

(22) Filed: Mar. 7, 2006

(51) Int. Cl. H04L 12/66

(52) U.S. Cl. 370/356

(57) ABSTRACT

Communicating configuration information for an end system includes generating an end system hello packet at an end system of a network. The end system corresponds to a host, and is operable to support the Internet Protocol (IP). An end system IP address identifying the end system is inserted into a field of the end system hello packet. The end system hello packet is sent to an intermediate system corresponding to a router of the network.

### TECHNICAL FIELD

This invention relates generally to the field of communication networks and more specifically to communicating configuration information for an end system.

### BACKGROUND

A communication network that supports a particular network protocol may be upgraded to support another or an additional protocol. As an example, a communication network that supports Open Systems Interconnection (OSI) protocols may be upgraded to support OSI and Internet Protocol (IP) protocols.

Typically, upgrading a communication network may involve introduction of network elements that support a new protocol. Known techniques for introducing network elements may involve manually provisioning devices. As an example, static routes may be manually provisioned on the network elements according to the new protocol. Manually provisioning devices, however, may not be efficient in certain situations. It is generally desirable to have efficient techniques for upgrading a communication network.

### SUMMARY OF THE DISCLOSURE

In accordance with the present invention, disadvantages and problems associated with previous techniques for communicating configuration information may be reduced or eliminated.

According to one embodiment of the present invention, communicating configuration information for an end system includes generating an end system hello packet at an end system of a network. The end system corresponds to a host, and is operable to support the Internet Protocol (IP). An end system IP address identifying the end system is inserted into a field of the end system hello packet. The end system hello packet is sent to an intermediate system corresponding to a router of the network.

Certain embodiments of the invention may provide one or more technical advantages. A technical advantage of one embodiment may be that a hello packet communicates the IP address of an end system to an intermediate system. Using the hello packet to communicate the IP address may allow for more efficient migration of a network from OSI protocols to OSI/IP protocols.

Another technical advantage of one embodiment may be that a network element that does not support IP protocols may ignore the IP address in the hello packet and use the OSI address in the hello packet. The presence of the OSI-only network element does not disrupt the communication, thus allowing for backward compatibility.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating a network system that is operable to communicate configuration information for an end system according to one embodiment of the invention;

FIG. 2 is a diagram illustrating one embodiment of a hello packet that may be used with the network system of FIG. 1 to communicate configuration information for an end system; and

FIG. 3 is a call flow diagram illustrating one embodiment of a method for communicating configuration information for an end system that may be used with the network system of FIG. 1.

### DETAILED DESCRIPTION OF THE DRAWINGS

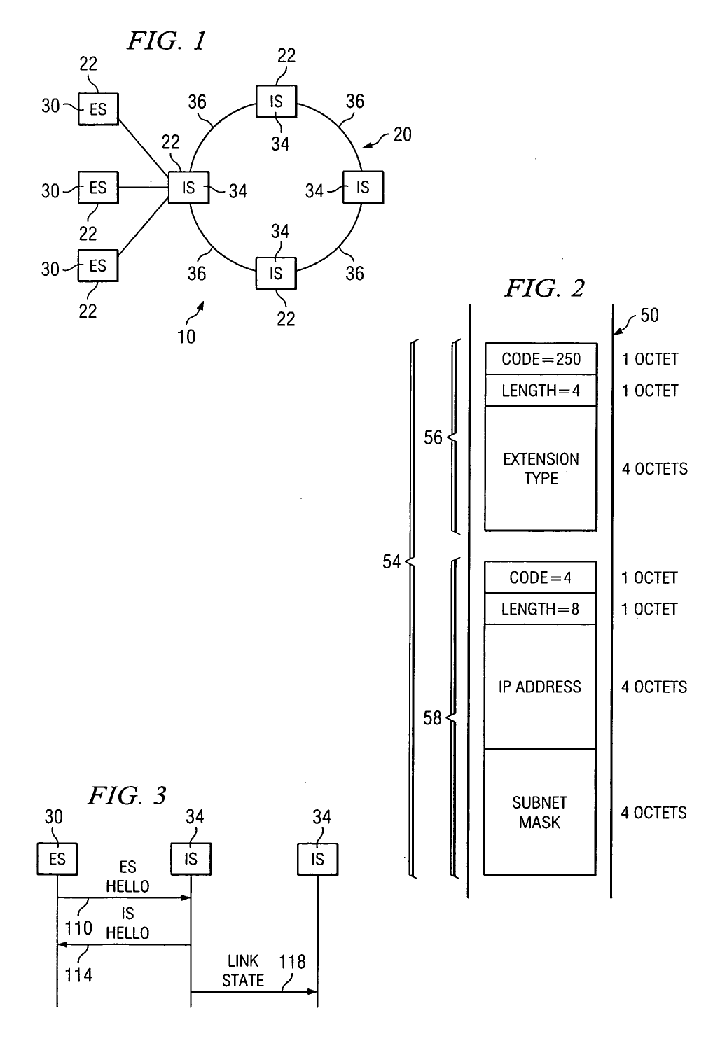

Embodiments of the present invention and its advantages are best understood by referring to FIGS. 1 through 3 of the drawings, like numerals being used for like and corresponding parts of the various drawings.

FIG. 1 is a block diagram illustrating a network system 10 that is operable to communicate configuration information for an end system 30 according to one embodiment of the invention. According to the embodiment, an end system 30 that supports IP protocols is added to network system 10. A hello packet communicates the IP address of the end system 30 to an intermediate system 34 of network system 10. Using the hello packet to communicate the IP address may allow for more efficient migration of a network from OSI protocols to OSI/IP protocols.

System 10 includes components such as devices. In general, a device may include any suitable arrangement of components operable to perform the operations of the device. As an example, a device may include logic, an interface, memory, other component, or any suitable combination of the preceding. “Logic” may refer to hardware, software, other logic, or any suitable combination of the preceding. Certain logic may manage the operation of a device, and may comprise, for example, a processor. “Processor” may refer to any suitable device operable to execute instructions and manipulate data to perform operations.

“Interface” may refer to logic of a device operable to receive input for the device, send output from the device, perform suitable processing of the input or output or both, or any combination of the preceding, and may comprise one or more ports, conversion software, or both.

“Memory” may refer to logic operable to store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Network system 10 communicates information through signals. A signal may refer to an optical signal transmitted as light pulses. As an example, an optical signal may have a frequency of approximately 1550 nanometers and a data rate of 10, 20, 40, or over 40 gigabits per second. A signal may comprise a synchronous transport signal (STS).

A signal may communicate information in packets. A packet may comprise a bundle of data organized in a specific way for transmission, and a frame may comprise the payload of one or more packets organized in a specific way for transmission. A packet may carry any suitable information such as voice, data, audio, video, multimedia, control, signaling, other information, or any combination of the preceding. The packets may comprise any suitable multiplexed packets, such as time division multiplexed (TDM) packets.

According to the illustrated embodiment, network system 10 includes one or more ring networks 20. A ring network 20 may include nodes 22 coupled by fibers 36 in a ring topology. Ring network 20 may have any suitable topology, for example, a unidirectional path-switched ring (UPSR) topology or a bidirectional line switched ring (BLSR) topology.

According to one embodiment, ring network 20 may comprise an optical fiber ring that utilizes protocols such as Resilient Packet Ring (RPR) protocols. An RPR protocol may refer to a protocol for ring-based packet transport, where packets are added, passed through, or dropped at each node 22. According to one embodiment, ring network 20 may utilize any suitable transmission technique, such as Ethernet, Synchronous Optical Network (SONET), or wavelength division multiplexing (WDM), such as dense wavelength division multiplexing (DWDM), techniques.

A node may comprise an end system (ES) 30 or an intermediate system (IS) 34. An end system 30 may refer to a non-routing node 22. According to one embodiment, an end system 30 may correspond to an IP host. In general, an end system 30 may have only one interface, and can route packets to only one point. Example end systems 30 include user devices, for example, computers, that may be used to access information or services.

An intermediate system 34 may refer to a routing node 22. According to one embodiment, an intermediate system 34 may correspond to an IP router. In general, an intermediate system 34 may have more than one interface and may make routing decisions to forward packets. Example intermediate systems 34 may include bridges, local area network (LAN) switches, routers, or network switches.

Fibers 36 may refer to any suitable fiber operable to transmit a signal. According to one embodiment, a fiber 36 may represent an optical fiber. An optical fiber typically comprises a cable made of silica glass or plastic. The cable may have an outer cladding material around an inner core. The inner core may have a slightly higher index of refraction than the outer cladding material. The refractive characteristics of the fiber operate to retain a light signal inside of the fiber.

A ring network 20 may have any suitable number of fibers 36, for example, two fibers 36. As an example, the first fiber 36 traverses a ring network 20 in one direction, and the second fiber traverses ring network 20 in the other direction. A ring segment may refer to the portion of fibers 36 between nodes 22, and may be designated by the specific ports of network elements coupled by the ring segment.

According to one embodiment, configuration information may be exchanged among systems 30 and 34 to allow for communication among systems 30 and 34. Configuration information allows end systems 30 to discover the existence and reachability of intermediate systems 34, and allows intermediate systems 34 to discover the existence and reachability of end systems 30.

According to the embodiment, various protocols may be used to exchange configuration information. The protocols may include an intermediate system-to-intermediate system (IS-IS) protocol and an end system-to-intermediate system (ES-IS) protocol. In one example, these protocols may be modified OSI protocols.

The IS-IS protocol may be used to allow intermediate systems 34 to communicate and share routing information among themselves. The ES-IS protocol may be used to allow end systems 30 to communicate and share limited routing information among themselves. The ES-IS protocol may be used to specify configuration of end systems 30 and intermediate systems 34 to allow for routing between end systems 30. End system 30 uses the address of intermediate system 34 (IS address) as the default routing gateway. In turn, intermediate system 34 propagates the address of end system 30 (ES address) and advertises the reachability of end system 30 through intermediate system 34.

A hello packet may be used to convey configuration information. ES hello packets (ESHs) are generated by end systems 30 and sent to intermediate systems 34 of network 20, and IS hello packets (ISHs) are generated by intermediate systems 34 and sent to end systems 30 of network 20. According to one embodiment, the hello packets may include the IP addresses of the systems that generated the hello packets. That is, an ES hello packet generated by end system 30 includes the IP address of end system 30, and an IS hello packet generated by intermediate system 34 includes the IP address of intermediate system 34.

The hello packets may include other suitable information. As an example, according to the OSI ES-IS protocol, the hello packets convey OSI addresses of the systems that generated the packets. OSI addresses may include OSI network layer addresses and OSI sub-network addresses.

Modifications, additions, or omissions may be made to network system 10 without departing from the scope of the invention. The components of network system 10 may be integrated or separated according to particular needs. Moreover, the operations of network system 10 may be performed by more, fewer, or other devices. Additionally, operations of network system 10 may be performed using any suitable logic. As used in this document, “each” refers to each member of a set or each member of a subset of a set.

Network system 10 may provide for efficient end system-to-intermediate system (ES-IS) configuration. In known OSI protocols, intermediate systems 34 exchange information to build a network topology, so intermediate systems 34 may easily communicate configuration information. End systems 34, however, do not have knowledge of the network topology, so end systems 34 cannot easily exchange configuration information. Network system 10 may provide for efficient exchange of information using hello packets. Moreover, the ES-IS configuration may be backwards compatible. Network elements that do not support IP protocols may simply ignore the IP addresses in the hello packets.

FIG. 2 is a diagram illustrating one embodiment of a hello packet 50 that may be used with network system 10 of FIG. 1 to communicate configuration information for an end system 30. Hello packet 50 includes an extension to the options field that may be used to communicate the end system IP address to intermediate system 34.

Hello packet 50 may use type-length-value (TLV) parameters to communicate information. TLV parameters communicate a type, length, and value. The type field indicates the type of items in the value field, the length field indicates the length of the value field, and the value field comprises the data portion of the packet. The fields may be identified by a specific number of octets, for example, one octet for the type field, one octet for the length field, and L octets for the value field.

According to the illustrated embodiment, hello packet 50 includes an options field 54. Options field 54 includes an extension identifier portion 56 and an IP address portion 58. Extension identifier portion 56 identifies the type of extensions contained in the options field. As an example, extension type may identify a manufacturer associated with the specific extension. IP address portion 58 communicates an IP address and a subnet mask.

Hello packet 50 may include other suitable information. According to one embodiment, hello packet 50 may comprise an OSI ES-IS hello packet that includes OSI addresses such as an OSI network layer address and an OSI sub-network address. An OSI network layer address identifies a network service access point (NSAP) or a network entity title (NET). A network services access point is interfaced between OSI Layer 3 and Layer 4. A network entity title is the network layer entity in an OSI intermediate system 34. OSI sub-network addresses are points at which end system 30 or intermediate system 34 is physically attached to a sub-network. A sub-network address uniquely identifies each system attached to the sub-network.

According to one embodiment, end system 30 may be configured to no longer support IP protocols. As an example, a particular location connection number (LCN) port may be provisioned as a default gateway. If end system 30 is configured to no longer support IP, IP address field 58 may be removed from hello packet 50. If intermediate system 34 notices that hello packet 50 no longer contains the end system IP address, the address may also be removed from the link state packets sent by intermediate system 34.

Modifications, additions, or omissions may be made to hello packet 50 without departing from the scope of the invention. Hello packet 50 may include more, fewer, or other fields or values. Moreover, the operations of hello packet 50 may be performed by any other suitable packet.

FIG. 3 is a call flow diagram 100 illustrating one embodiment of a method for communicating configuration information for an end system 30 that may be used with network system 10 of FIG. 1. According to the embodiment, hello packets convey IP addresses of the systems that generated the hello packets. The hello packets may be simultaneously sent to many systems. As an example, in broadcast sub-networks, hello packets may be sent to intermediate systems 34 through a special multicast address that designates the end systems 30.

End system 30 advertises itself to intermediate system 34 at step 110 by sending configuration information to intermediate system 34 in an ES hello packet 50. ES hello packet 50 includes the ES IP address for end system 30. If intermediate system 34 does not support IP protocols, intermediate system 34 ignores the ES IP address.

Intermediate system 34 sends configuration information to end system 30 in an IS hello packet 50 at step 114. IS hello packet 50 includes the IS IP address of intermediate system 34. IS hello packet 50 may include a protocol supported portion that indicates the protocols supported by intermediate system 34. The protocol supported portion may indicate that intermediate system 34 supports the IP protocol and any other suitable protocol, for example, the connectionless network protocol (CLNP).

End system 30 receives IS hello packet 50, and sends IP packets to the IS IP address in the IS hello packet. That is, end system 30 treats intermediate system 34 as the default gateway for IP packets sent from end system 30. If end system 30 does not support IP protocols, end system 30 ignores the IS IP address.

Intermediate system 34 advertises end system 30 to other nodes 22 of network 20 at step 118 by sending the ES IP address as the reachable address for end system 30. A reachable address for a network element refers to the address at which the network element may be reached. Intermediate system may place the IS IP address in an L1 link state packet (LSP) to advertise the ES IP address.

Other intermediate systems 34 of network 20, including third party systems, treat end system 30 as a static route reachable through intermediate system 34. As an example, the other intermediate systems 34 may include end system 30 in their Dijkstra calculations.

Modifications, additions, or omissions may be made to the method without departing from the scope of the invention. The method may include more, fewer, or other steps. Additionally, steps may be performed in any suitable order without departing from the scope of the invention.

According to one embodiment, end system 30 may be explicitly provisioned to not participate in IP communication with intermediate system 34. As an example, a non-IP port may be provisioned as the default gateway. According to the embodiment, end system 30 advertises only OSI addresses in the ES hello packet. In addition, traffic, including IP-based traffic, is directed over the non-IP port.

Certain embodiments of the invention may provide one or more technical advantages. A technical advantage of one embodiment may be that a hello packet communicates the IP address of an end system to an intermediate system. Using the hello packet to communicate the IP address may allow for more efficient migration of a network from OSI protocols to OSI/IP protocols.

Another technical advantage of one embodiment may be that a network element that does not support IP protocols may ignore the IP address in the hello packet and use the OSI address in the hello packet. The presence of the OSI-only network element does not disrupt the communication, thus allowing for backward compatibility.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for communicating configuration information for an end system, comprising:
generating an end system hello packet at an end system of a network, the end system corresponding to a host, the end system operable to support the Internet Protocol (IP);
inserting an end system IP address into a field of the end system hello packet, the end system IP address identifying the end system; and
sending the end system hello packet to an intermediate system of the network, the intermediate system corresponding to a router.

2. The method of claim 1, further comprising:
receiving the end system hello packet at the intermediate system; and
notifying the network of the end system IP address if the intermediate system is operable to support IP, the notification indicating that the end system is reachable through the end system IP address.

3. The method of claim 1, further comprising:
receiving the end system hello packet at the intermediate system; and
ignoring the end system IP address if the intermediate system is not operable to support IP.

4. The method of claim 1, further comprising:
sending an intermediate system hello packet from the intermediate system to the end system, the intermediate system hello packet comprising an intermediate system IP address, the intermediate system IP address identifying the intermediate system.

5. The method of claim 1, wherein:
the end system hello packet comprises an Open System Interconnection (OSI) end system-intermediate system (ES-IS) protocol hello packet; and
the end system hello packet comprises an option field, the option field comprising a plurality of parameters, the parameters indicating the end system IP address.

6. The method of claim 1, further comprising:
configuring a port of the end system as a default port; and
sending a next end system hello packet, the end system IP address absent from the next end system hello packet.

7. A system for communicating configuration information for an end system, comprising:
an end system corresponding to a host, the end system operable to support the Internet Protocol (IP), the end system further operable to:
generate an end system hello packet at an end system of a network;
insert an end system IP address into a field of the end system hello packet, the end system IP address identifying the end system; and
send the end system hello packet to an intermediate system of the network, the intermediate system corresponding to a router.

8. The system of claim 7, further comprising the intermediate system, the intermediate system further operable to:
receive the end system hello packet; and
notify the network of the end system IP address if the intermediate system is operable to support IP, the notification indicating that the end system is reachable through the end system IP address.

9. The system of claim 7, further comprising the intermediate system, the intermediate system further operable to:
receive the end system hello packet; and
ignore the end system IP address if the intermediate system is not operable to support IP.

10. The system of claim 7, further comprising the intermediate system, the intermediate system further operable to:
send an intermediate system hello packet to the end system, the intermediate system hello packet comprising an intermediate system IP address, the intermediate system IP address identifying the intermediate system.

11. The system of claim 7, wherein:
the end system hello packet comprises an Open System Interconnection (OSI) end system-intermediate system (ES-IS) protocol hello packet; and
the end system hello packet comprises an option field, the option field comprising a plurality of parameters, the parameters indicating the end system IP address.

12. The system of claim 7, wherein:
the end system further comprises:
a port configured as a default port; and
the end system is further operable to:
send a next end system hello packet, the end system IP address absent from the next end system hello packet.

13. Logic for communicating configuration information for an end system, the logic embodied in a medium and operable to:
generate an end system hello packet at an end system of a network, the end system corresponding to a host, the end system operable to support the Internet Protocol (IP);
insert an end system IP address into a field of the end system hello packet, the end system IP address identifying the end system; and
send the end system hello packet to an intermediate system of the network, the intermediate system corresponding to a router.

14. The logic of claim 13, further operable to:
receive the end system hello packet at the intermediate system; and
notify the network of the end system IP address if the intermediate system is operable to support IP, the notification indicating that the end system is reachable through the end system IP address.

15. The logic of claim 13, further operable to:
receive the end system hello packet at the intermediate system; and
ignore the end system IP address if the intermediate system is not operable to support IP.

16. The logic of claim 13, further operable to:
send an intermediate system hello packet from the intermediate system to the end system, the intermediate system hello packet comprising an intermediate system IP address, the intermediate system IP address identifying the intermediate system.

17. The logic of claim 13, wherein:
the end system hello packet comprises an Open System Interconnection (OSI) end system-intermediate system (ES-IS) protocol hello packet; and
the end system hello packet comprises an option field, the option field comprising a plurality of parameters, the parameters indicating the end system IP address.

18. The logic of claim 13, further operable to:
configure a port of the end system as a default port; and
send a next end system hello packet, the end system IP address absent from the next end system hello packet.

19. One or more data signals for communicating configuration information for an end system, a data signal of the one or more data signals comprising an end system hello packet generated at the end system, the end system hello packet comprising:
a first address field comprising an Open System Interconnection (OSI) address for the end system; and
a second address field comprising an end system Internet Protocol (IP) address identifying the end system, the end system hello packet addressed to an intermediate system of the network.

20. The one or more data signals of claim 19, further comprising:
a next data signal comprising an intermediate system hello packet, the intermediate system hello packet generated by the intermediate system, the intermediate system hello packet comprising an intermediate system IP address, the intermediate system IP address identifying the intermediate system.

21. The one or more data signals of claim 19, wherein:
the end system hello packet comprises an Open System Interconnection (OSI) end system-intermediate system (ES-IS) protocol hello packet.

22. The one or more data signals of claim 19, wherein:
the second address field comprises a plurality of parameters, the parameters indicating the end system IP address.

23. A system for communicating configuration information for an end system, comprising:
means for generating an end system hello packet at an end system of a network, the end system corresponding to a host, the end system operable to support the Internet Protocol (IP);
means for inserting an end system IP address into a field of the end system hello packet, the end system IP address identifying the end system; and
means for sending the end system hello packet to an intermediate system of the network, the intermediate system corresponding to a router.

24. A method for communicating configuration information for an end system, comprising:
generating an end system hello packet at an end system of a network, the end system corresponding to a host, the end system operable to support the Internet Protocol (IP), the end system hello packet comprising an Open System Interconnection (OSI) end system-intermediate system (ES-IS) protocol hello packet, the end system hello packet comprising an option field, the option field comprising a plurality of parameters, the parameters indicating the end system IP address;
inserting an end system IP address into a field of the end system hello packet, the end system IP address identifying the end system;
sending the end system hello packet to an intermediate system of the network, the intermediate system corresponding to a router;
receiving the end system hello packet at the intermediate system;
notifying the network of the end system IP address if the intermediate system is operable to support IP, the notification indicating that the end system is reachable through the end system IP address;
ignoring the end system IP address if the intermediate system is not operable to support IP; and
sending an intermediate system hello packet from the intermediate system to the end system, the intermediate system hello packet comprising an intermediate system IP address, the intermediate system IP address identifying the intermediate system;
configuring a port of the end system as a default port; and
sending a next end system hello packet, the end system IP address absent from the next end system hello packet.
